(19) United States
(12) Patent Application Publication
(10) Pub. No.: US 2014/0127924 A1
(43) Pub. Date: May 8, 2014

(54) CHARGE CONNECTOR LOCKING APPARATUS

(71) Applicant: Seon-Ah Kim, Incheon (KR)

(72) Inventor: Seon-Ah Kim, Incheon (KR)

(73) Assignee: KOREA ELECTRIC TERMINAL CO., LTD., Incheon (KR)

(21) Appl. No.: 14/123,193

(22) PCT Filed: May 31, 2012
(86) PCT No.: PCT/KR2012/004287

§ 371 Date: Nov. 29, 2013

(30) Foreign Application Priority Data
May 31, 2011 (KR) 10-2011-0051777
Jun. 8, 2011 (KR) 10-2011-0055257
Dec. 13, 2011 (KR) 10-2011-0133329

(51) Int. Cl. H01R 13/639

(52) U.S. Cl. CPC H01R 13/639
USPC 439/299

(57) ABSTRACT

The present invention relates to a charging connector locking apparatus. The apparatus includes a coupling latch installed in an inlet housing of the inlet connector to be supported by a resilient member such that the plug connector is guided along a plug housing of the plug connector as the plug connector is inserted into the inlet connector; a driving source for providing power for locking and releasing the coupling latch; and a locking lever driven by the driving source to control movement of the coupling latch, for fixing the coupling latch in a state in which the coupling latch is positioned in a coupling hole of the plug housing while the plug connector is coupled to the inlet connector.

### BACKGROUND OF THE INVENTION

1. Field of the Invention

The present invention relates to a charging connector locking apparatus, and more particularly to a charging connector locking apparatus that locks a state in which a plug connector for charging a battery of a vehicle and an inlet connector are coupled to each other to maintain the coupled state during the charging of the battery.

2. Description of the Prior Art

An inlet connector for charging is provided at one side of a vehicle that uses electricity as main power or as at least a part of main power. A plug connector of a charging station is inserted into and coupled to the inlet connector. The plug connector is coupled and electrically connected to the inlet connector to supply electric power to a battery of a vehicle so as to charge the battery. An example of the inlet connector and the plug connector is illustrated in FIG. 1 of Japanese Patent No. 1995-85926.

Generally, the inlet connector and the plug connector are prevented from being arbitrarily released by an unintended external force with a coupling structure, but the coupling structure may be easily released through manipulation of a person. Thus, the plug connector may be released and separated from the inlet connector by a mistake or an ignorance of an operator for charging or a third person during the charging operation. By doing so, the plug connector may generate a spark in the process of separating the plug connector from the inlet connector, causing a fire.

In order to prevent the situation, it is preferable that a locking apparatus for locking the coupled state is provided in the inlet connector. Generally, a standard structure is provided in the inlet connector and the plug connector such that they can be coupled to each other even if they are produced by different manufacturers. Thus, the automobile manufacturers want to lock the coupled state by providing a locking apparatus to a vehicle even when the plug connector and the inlet connector are not provided with a locking apparatus.

Generally, when the inlet connector and the plug connector are coupled to each other, the plug connector is inserted into the inlet connector. However, it can be determined whether the inlet connector and the plug connector are accurately finished only through identifying the coupled state of the inlet connector and the plug connector by eyes of the operator.

However, since a tip end of the plug connector is inserted into the inlet connector to be hidden when the inlet connector and the plug connector are coupled to each other, the coupled state cannot be visually determined perfectly. Thus, in order to finish the coupled state, the operator applies a relatively strong force to the plug connector to push the plug connector into the inlet connector. In this process, an excessive force is applied to the inlet connector by the plug, so that the inlet connector may be damaged in a severe case.

### SUMMARY OF THE INVENTION

Accordingly, the present invention has been made in an effort to overcome the above problems, and it is an object to provide a locking apparatus for locking a plug connector coupled to an inlet connector for charging of a vehicle.

It is an another object of the present invention to allow an operator to determine whether an inlet connector for charging a battery of a vehicle and a plug connector is completely coupled with a feeling other than a visual feeling.

In accordance with an aspect of the present invention, there is provided a charging connector locking apparatus for locking a coupled state of an inlet connector and a plug connector of a charging station when the inlet connector is coupled to the plug connector for charging, the apparatus including: a coupling latch installed in an inlet housing of the inlet connector to be supported by a resilient member such that the plug connector is guided along a plug housing of the plug connector as the plug connector is inserted into the inlet connector; a driving source for providing power for locking and releasing the coupling latch; and a locking lever driven by the driving source to control movement of the coupling latch, for fixing the coupling latch in a state in which the coupling latch is positioned in a coupling hole of the plug housing while the plug connector is coupled to the inlet connector.

The driving source is located at one side of a mounting plate formed in an inlet housing of the inlet connector.

A mounting plate is formed in an inlet housing of the inlet connector and an adapter bracket is provided along a periphery of the mounting plate, a bracket body is formed in the adapter bracket along a periphery of the mounting plate to have a predetermined height, a penetration part through which a plug insertion part of the inlet housing is exposed is formed to pass through a center of the bracket body, and a mounting piece for mounting the adapter bracket to a panel of a vehicle is formed at one side of the bracket body.

A driving source housing in which the driving source is positioned is integrally formed with one side of the adapter bracket and the locking lever passes through the bracket body such that an interior of the driving source housing is communicated with the penetration part.

A first inclined surface and a second inclined surface guided by the plug housing are provided in the latch body forming a frame of the coupling latch to face each other, and an interlocking arm having an interlocking inclined surface for interlocking with the locking lever protrudes from one side of the latch body.

An arm interlocking inclined surface that mutually guides an interlocking inclined surface is formed in a lever body forming a frame of the locking lever at a location corresponding to the interlocking inclined surface, and interlocking fingers having end interlocking inclined surfaces interlocking with interlocking inclined surfaces formed at opposite sides of the interlocking arm are formed at opposite sides of the arm interlocking inclined surface.

A movement guide rib or a movement guide channel extends in a lengthwise direction of the locking lever.

In accordance with an aspect of the present invention, there is provided a charging connector locking apparatus for locking a coupled state of an inlet connector and a plug connector of a charging station when the inlet connector is coupled to the plug connector for charging, the apparatus including: a coupling latch passing through an insertion hole passing through a plug insertion part formed in an inlet housing of the inlet connector to be guided along a plug housing of the plug connector as the plug connector is inserted into the inlet connector, and supported by a resilient member; a driving source for providing power for locking and releasing the coupling latch; and a locking lever installed in the inlet housing and driven by the driving source to control movement of the coupling latch, for fixing the coupling latch in a state the coupling latch is positioned in a coupling hole of the plug housing while the plug connector is coupled to the inlet connector.

An adapter bracket having a mounting piece mounted to a panel of a vehicle is provided along a periphery of a mounting plate of the inlet housing, a bracket body is formed in the adapter bracket along a periphery of the mounting plate to have a predetermined height, a penetration part through which a plug insertion part of the inlet housing is exposed is formed to pass through a center of the bracket body, a driving source housing in which the driving source is positioned is integrally formed with one side of the bracket body, and the locking lever is passed through such that an interior of the driving source housing is communicated with the penetration part via the bracket body.

A first inclined surface and a second inclined surface guided by the plug housing is provided in a latch body forming a frame of the coupling latch to extend in a direction perpendicular to a movement direction of the locking lever so as to face each other, and an interlocking arm having an interlocking inclined surface for interlocking with the locking lever is formed at one side of the latch body to protrude in a movement direction of the locking lever.

An arm interlocking inclined surface that mutually guides the interlocking inclined surface is formed in a lever body forming a frame of the locking lever at a location corresponding to the interlocking inclined surface, and interlocking fingers formed having end interlocking inclined surfaces interlocking with the interlocking inclined surface formed at opposite sides of the interlocking arm at tip ends thereof are provided at opposite sides of the arm interlocking inclined surface.

A tip end inclined surface interlocking with a first inclined surface of the coupling latch is formed at a tip end of the plug housing, and an inner inclined surface interlocking with a second inclined surface of the coupling latch is formed in a coupling hole of the plug housing.

In accordance with an aspect of the present invention, there is provided a charging connector locking apparatus for locking a coupled state of an inlet connector and a plug connector of a charging station when the inlet connector is coupled to the plug connector for charging, the apparatus including: a coupling latch installed at one side of an inlet housing of the inlet connector and supported by a resilient member at a location deviating from a movement passage through which the plug connector moves; and a locking lever configured to control movement of the coupling latch, for fixing the coupling latch in a state the coupling latch is positioned in a coupling hole of the plug connector while the plug connector is coupled to the inlet connector.

The apparatus further includes a driving source for driving the locking lever, wherein the driving source is operated in a state in which terminals of the plug connector and the inlet connector are coupled to each other to drive the locking lever.

The apparatus further includes a switch provided at a location adjacent to the coupling latch, for detecting a state in which the coupling latch is moved and fixed by the locking lever.

A mounting plate is formed at a rear end of the inlet housing, an adapter bracket is provided along a periphery of the mounting plate, a bracket body is formed in the adapter bracket along a periphery of the mounting plate to have a predetermined height, a penetration part through which a plug insertion part of the inlet housing is exposed is formed to pass through a center of the bracket body, and a mounting piece for mounting an adapter bracket to a panel of a vehicle is formed at one side of the bracket body.

A driving source housing in which the driving source is positioned is integrally formed with one side of the adapter bracket and the locking lever passes through the bracket body such that an interior of the driving source housing is communicated with the penetration part.

The coupling latch and the locking lever are installed in a mounting plate formed in an inlet housing of the inlet connector and a positioning plate formed in a penetration part of the adapter bracket.

An interlocking inclined surface guiding a driving inclined surface at a tip end of the locking lever is formed at one end of a latch body forming a frame of the coupling latch, and a locking bar protrudes from one surface of the latch body to be located in an insertion hole of the inlet connector and a coupling hole of the plug connector.

One end of a resilient member supporting the coupling latch is positioned in a positioning recess formed around a locking bar of the latch body, and an opposite end of the resilient member is positioned in a positioning recess formed around an insertion hole passing through the plug coupling part provided in the inlet connector.

A tip end of the locking bar of the coupling latch is curved, and is located in the insertion hole by the resilient member and is inserted into a coupling hole of the plug connector by the locking member.

In accordance with another aspect of the present invention, there is provided a charging connector locking apparatus for locking a coupled state of an inlet connector and a plug connector of a charging station when the inlet connector is coupled to the plug connector for charging, the apparatus including: a coupling latch supported by a resilient member of the plug connector in a direction away from a coupling hole formed in the plug connector such that a tip end of the coupling latch is located in an insertion hole formed at one side of an inlet housing of the inlet connector; a driving source for providing driving power for insertion of the coupling latch into the coupling hole of the plug connector; and a locking lever operated by the driving source to control movement of the coupling latch, for moving and fixing the coupling latch such that the coupling latch is positioned in a coupling hole of the plug connector while the plug connector is coupled to the inlet connector.

An interlocking inclined surface guiding a driving inclined surface at a tip end of the locking lever is formed at one end of the latch body forming a frame of the coupling latch, and a locking bar protrudes from one surface of the latch body to be pushed by the locking lever so as to be located in an insertion hole of the inlet connector and a coupling hole of the plug connector.

One end of a resilient member supporting the coupling latch is positioned in a positioning recess formed around a locking bar of the latch body, and an opposite end of the resilient member is positioned in a positioning recess formed around an insertion hole passing through the plug coupling part provided in the inlet connector.

A tip end of the locking bar of the coupling latch is curved, and is located in the insertion hole by the resilient member and is inserted into a coupling hole of the plug connector by the locking member.

The apparatus further includes a switch provided at a location adjacent to the coupling latch, for detecting a state in which the locking lever is moved and fixed by the locking lever.

A mounting plate is formed at a rear end of the inlet housing, an adapter bracket is provided along a periphery of the mounting plate, a bracket body is formed in the adapter bracket along a periphery of the mounting plate to have a predetermined height, a penetration part through which a plug insertion part of the inlet housing is exposed is formed to pass through a center of the bracket body, and a mounting piece for mounting an adapter bracket to a panel of a vehicle is formed at one side of the bracket body.

A driving source housing in which the driving source is positioned is integrally formed with one side of the adapter bracket and the locking lever passes through the bracket body such that an interior of the driving source housing is communicated with the penetration part.

In accordance with another aspect of the present invention, there is provided a charging connector locking apparatus for fixing a state in which an inlet connector for charging is coupled to a plug connector of a charging station, the apparatus including: a box formed at one side of a housing forming an external appearance of the inlet connector and having a receiving space therein; and a plunger formed at one side of the housing, and having a ball portion passing through a plug insertion part into which a tip end of the plug connector is inserted to be supported by a resilient member in the receiving space of the box and protruding into a plug insertion part toward an outer surface of a plug housing of the plug connector, wherein the ball portion protrudes into the plug insertion part to be positioned in a positioning part formed in the plug housing by a resilient force of the resilient member.

A ball through-hole passes through the plug insertion part to communicate the receiving space of the box with an interior of the plug insertion part.

The plunger includes: a body located within the receiving space and having a size larger than the ball through-hole; and a ball portion protruding from a tip end of the body and located in the ball through-hole such that a tip end of the ball portion is curved to protrude into the plug insertion part so as to be guided along an outer surface of the plug housing of the plug connector.

A tip end of the ball portion is curved at least in a movement direction of the plug connector.

A plurality of plungers are installed within the plug insertion part at a predetermined separation.

The plug insertion part protrudes from a front surface of the mounting plate in the housing, and the box is formed on a front surface of the mounting plate and shielded by a tip end cover.

The charging connector locking apparatus according to the present invention has the following effects.

If an inlet connector provided in a vehicle to charge the vehicle and a plug connector in a charging station are coupled to each other, a coupling latch of an inlet connector is caught by one side of the plug connector and a locking lever driven by a driving source fixes the coupling latch so that the coupling latch cannot be moved. Thus, the plug connector is prevented from being arbitrarily separated during the charging to safely perform the charging.

Further, since the driving source for driving the locking lever is fixed to an inlet housing of the inlet connector or fixed to an adapter bracket fixed to the inlet housing such that the locking lever can be operated at a location adjacent to the coupling latch, power transmission efficiency and operation characteristics become excellent.

Furthermore, since an adapter bracket is employed, the inlet connector can be commonly used. In addition, since a driving source is installed in the adapter bracket and the locking lever passes through the adapter bracket to be connected to the driving source, a waterproofing effect can be enhanced.

Furthermore, since a switch detects a state in which the coupling latch is coupled to the plug connector, the coupled state of the charging connector by the coupling latch can be accurately determined.

When the inlet connector provided in the vehicle to charge the battery and the plug connector of the charging station are coupled to each other, the coupled state can be determined by an operator by using a feeling other than a visual feeling. That is, a ball supported by a resilient member is installed in the inlet connector such that the ball is pushed by the plug connector at a time point when the plug connector is completely coupled to the inlet connector and returns to an original location. Thus, the operator can feel a coupling feeling and hear a coupling sound, thereby feeling a complete insertion of the plug connector with a feeling other than a visual feeling.

### BRIEF DESCRIPTION OF THE DRAWINGS

The above and other objects, features and advantages of the present invention will be more apparent from the following detailed description taken in conjunction with the accompanying drawings, in which:

FIG. 1 is a front perspective view illustrating an inlet connector employing a charging connector locking apparatus according to an embodiment of the present invention;

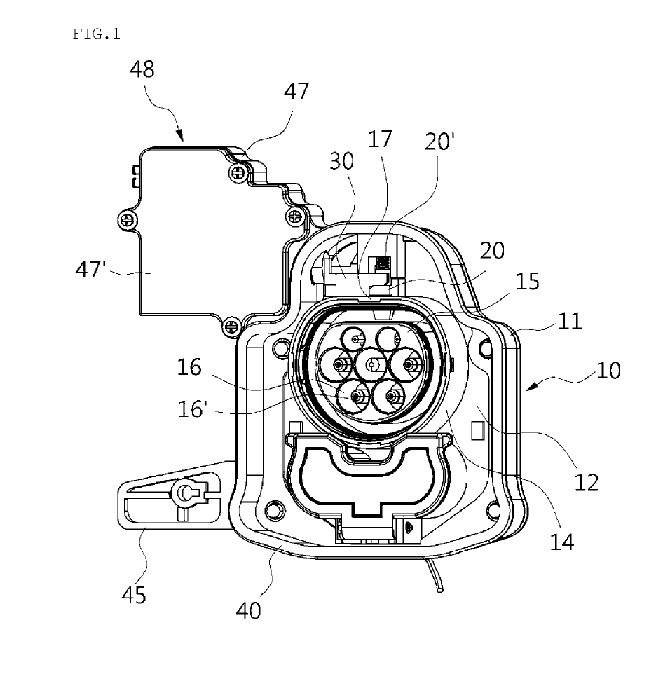

FIG. 2 is a sectional perspective view illustrating a main part of the charging connector locking apparatus according to the embodiment of the present invention;

FIG. 3 is a perspective view illustrating an inlet housing of the charging connector locking apparatus according to the embodiment of the present invention;

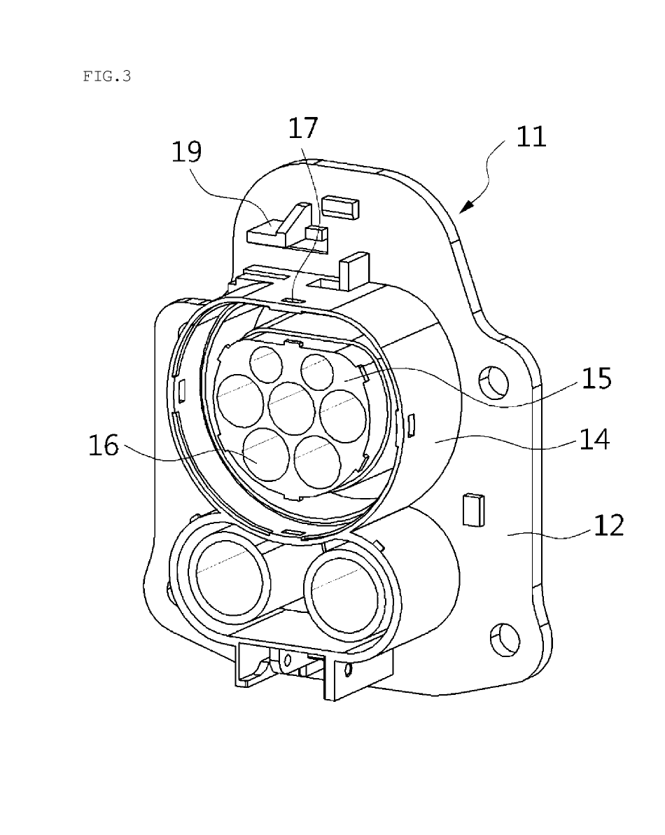

FIG. 4 is a perspective view illustrating a locking lever and a coupling latch of the charging connector locking apparatus according to the embodiment of the present invention;

FIG. 5 is a bottom perspective view illustrating the locking lever of the charging connector locking apparatus according to the embodiment of the present invention;

FIG. 6 is a perspective view illustrating an adapter bracket of the charging connector locking apparatus according to the embodiment of the present invention;

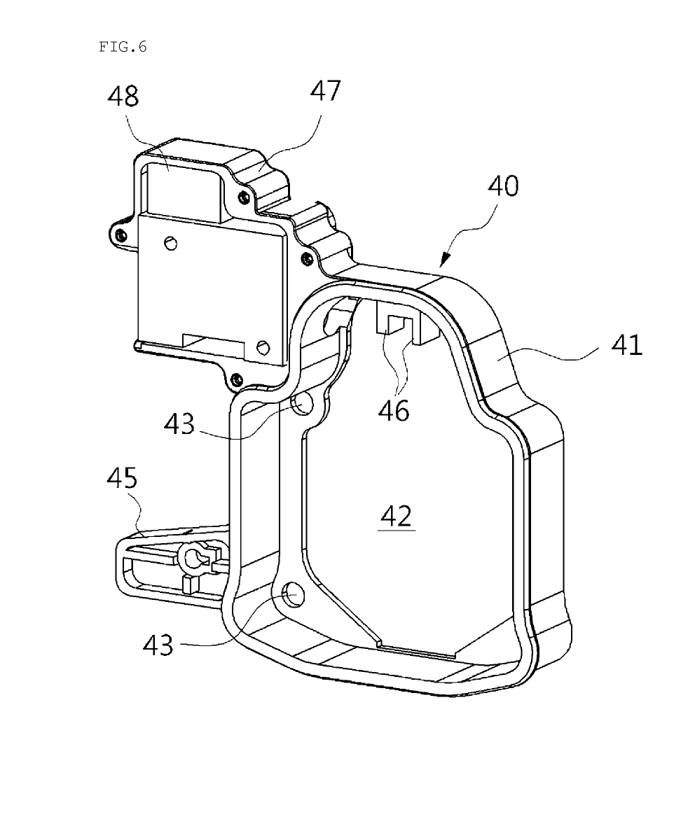

FIG. 7 sequentially illustrates an operation of the charging connector locking apparatus according to the embodiment of the present invention;

FIG. 8 is a perspective view illustrating an inlet connector employing a charging connector locking apparatus according to another embodiment of the present invention;

FIG. 9 is a sectional perspective view illustrating a main part of the charging connector locking apparatus according to the other embodiment of the present invention;

FIG. 10 is a perspective view illustrating an inlet housing of the charging connector locking apparatus according to the other embodiment of the present invention;

FIG. 11 is a perspective view illustrating a locking lever and a coupling latch of the charging connector locking apparatus according to the other embodiment of the present invention;

FIG. 12 is a bottom perspective view illustrating the coupling latch of the charging connector locking apparatus according to the other embodiment of the present invention when the coupling latch is viewed from another side;

FIG. 13 is a perspective view illustrating an adapter bracket of the charging connector locking apparatus according to the other embodiment of the present invention;

FIG. 14 sequentially illustrates an operation of the charging connector locking apparatus according to the other embodiment of the present invention;

FIG. 15 is a perspective view illustrating an inlet connector employing a charging connector locking apparatus according to another embodiment of the present invention;

FIG. 16 is a front perspective view illustrating a state in which a front cover of the inlet connector employing the charging connector locking apparatus according to the embodiment of the present invention is removed;

FIG. 17 is a sectional perspective view illustrating a main part of the charging connector locking apparatus according to the other embodiment of the present invention; and

FIGS. 18 and 19 illustrate an operation of the charging connector locking apparatus according to the other embodiment of the present invention.

### DETAILED DESCRIPTION OF THE PREFERRED EMBODIMENTS

Hereinafter, charging connector locking apparatuses according to exemplary embodiments of the present invention will be described in detail with reference to the accompanying drawings.

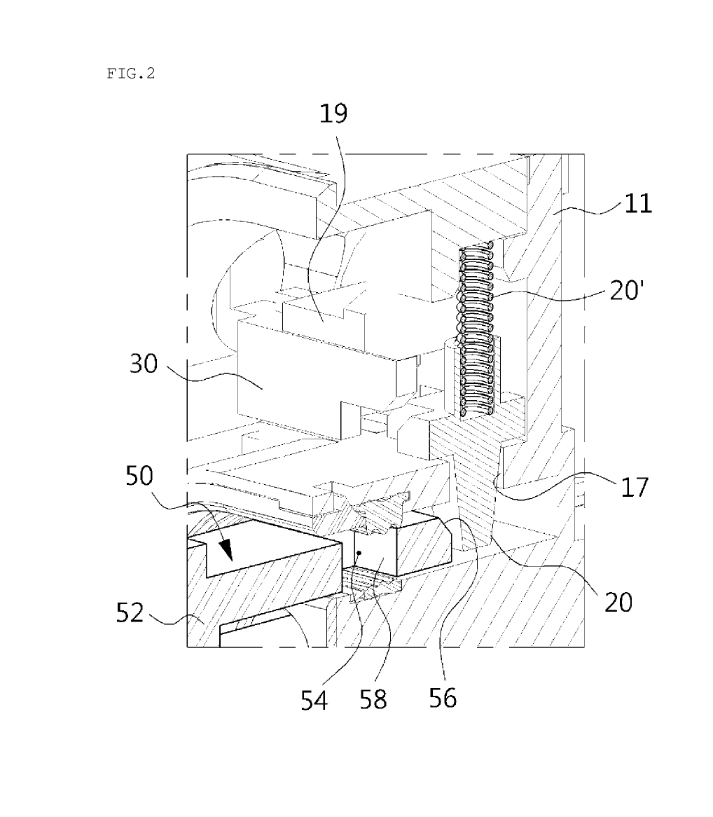

As illustrated in the drawings, an inlet connector 10 is adapted to charge a vehicle, and is a part mounted to one side of a vehicle such that a plug connector 50 (see FIG. 2) of a charging station is coupled thereto. An inlet housing 11 forms an external appearance and a frame of the inlet connector 10. The inlet housing 11 is formed of a synthetic resin. A mounting plate 12 formed of an insulating synthetic resin is provided at a rear end of the inlet housing 11. A plug coupling part 14 that is substantially cylindrical protrudes from the mounting plate 12. A terminal installation part 15 that is cylindrical is formed in an interior of the plug coupling part 14. A terminal positioning space 16 passes through the terminal installation part 15 forward and rearward. A terminal 16′ formed of a conductive metal is located within the terminal positioning space 16.

An insertion hole 17 is formed at one side of an outer surface of the plug coupling part 14. The insertion hole 17 is a part through which the coupling latch 20, which will be described below, passes. The insertion hole 17 is a part that corresponds to a coupling hole 54 provided in a plug connector of a charging station when the plug connector 50 of the charging station is coupled to the inlet connector 10. For reference, a description of parts of the inlet connector 10 that do not correspond to the essence of the present invention will be omitted.

The coupling latch 20 is installed in the mounting plate 12 of the inlet housing 11 to pass through the insertion hole 17 of the plug insertion part 14. One end of the coupling latch 20 is supported by a resilient member 20′ to receive a force in a direction in which the coupling latch 20 is inserted into the insertion hole 17. In the embodiment of the present invention, a cylindrical coil spring is used as the resilient member 20′. The coupling latch 20 is located in the insertion hole 17 and the coupling hole 54 of the plug connector 50 at the same time to lock the inlet connector 10 and the plug connector 50 coupled to each other.

A lever guide 19 protrudes from the mounting plate 12. A gap corresponding to a height of a locking lever 30, which will be described below, is formed between the lever guide 19 and an outer surface of the plug coupling part 14. The locking lever 30 is moved between the lever guide 19 and the plug coupling part 14.

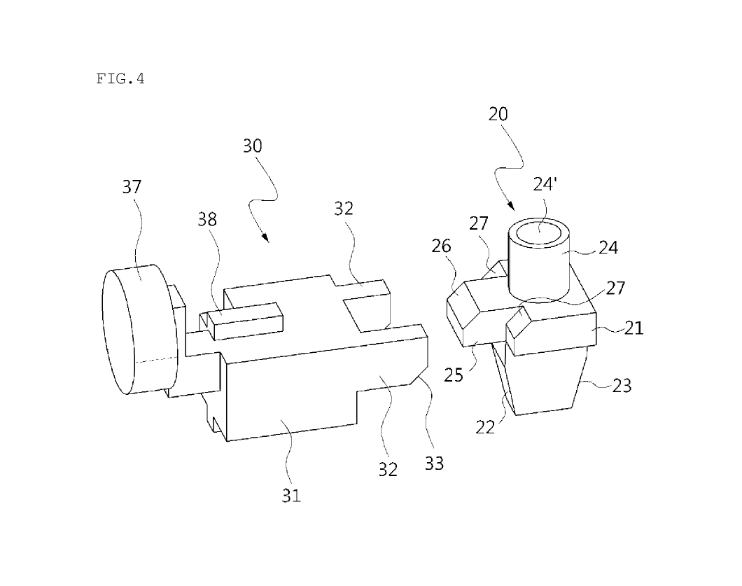

A shape of the coupling latch 20 is illustrated in FIG. 4. A latch body 21 forms a frame of the coupling latch 20. An end of the latch body 21 has a quadrangular pyramid frustum shape. Of course, the shape of the latch body 21 is not limited thereto. A first inclined surface 22 and a second inclined surface 23 are formed on opposite surfaces of the latch body 21. The first inclined surface 22 and the second inclined surface 23 are inclined such that they become closer as they go toward an end of the latch body 21, that is, a lower side of the drawing.

A connecting part 24 is provided at an opposite end of the latch body 21, that is, at an upper end of the latch body 21 in the drawing. One end of the resilient member 20′ is positioned in the connecting part 24, and a positioning hole 24 is formed in the connecting part 24. In the embodiment of the present invention, the connecting part 24 has a cylindrical shape.

An interlocking arm 25 protrudes from a side of the latch body 21 where the first inclined surface 22 is located. The interlocking arm 25 extends in a direction perpendicular to a lengthwise direction of the latch body 21, that is, in a direction perpendicular to a movement direction of the locking lever 30, which will be described below. An interlocking inclined surface 26 is inclined downwards toward a tip end of the interlocking arm 25 above the tip end of the interlocking arm 25. The interlocking inclined surface 26 is adapted to interlock with the locking lever 30, which will be described below. A width of the interlocking arm may be equal to or larger than an outer diameter of the connecting part 24. An end interlocking inclined surface 27 is formed in the latch body 21 corresponding to opposite sides of the interlocking arm 25 in the same manner as the interlocking inclined surface 26. An inclination angle of the end interlocking inclined surface 27 may be the same as the interlocking inclined surface 26 of the interlocking arm 25.

The locking lever 30 is provided to interlock with the coupling latch 20. The locking lever 30 is provided in the mounting plate 12 of the inlet housing 11 and serves to drive the coupling latch 20. The lever body 31 forms a frame of the locking lever 30. In the embodiment of the present invention, the lever body 31 has a substantially hexahedral shape.

A pair of interlocking fingers 32 are provided at a tip end of the lever body 31. An end interlocking inclined surface 33 is formed at a lower side of a tip end of each of the interlocking fingers 32. The end interlocking inclined surface 33 is a part that mutually guides the end interlocking inclined surface 27 of the coupling latch 20. A distance between the end interlocking inclined surface 33 and the interlocking finger 32 is larger than a width of the interlocking arm 25 of the coupling latch 20.

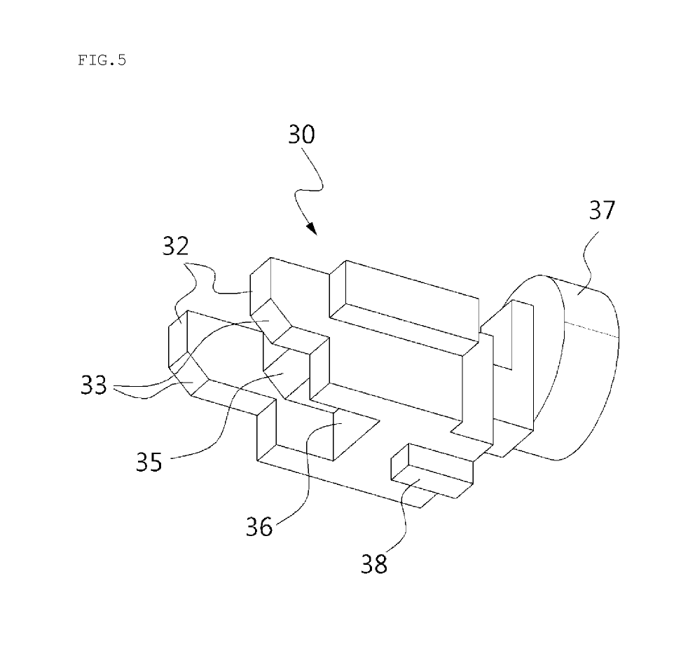

As illustrated in FIG. 5, an arm interlocking inclined surface 35 is formed at a tip end of the lever body 31 located between the interlocking fingers 32. The arm interlocking inclined surface 35 is a part that mutually guides the interlocking inclined surface 26 formed in the interlocking arm 25 of the coupling latch 20.

An avoidance space 36 is formed at an end of the arm interlocking inclined surface 35 to be recessed inward of the lever body 31. The avoidance space 36 is a part in which the interlocking arm 25 is positioned when the coupling latch 20 and the locking lever 30 interlock with each other.

A connecting disk 37 is formed at a rear end of the lever body 31. The connecting disk 37 is a part that connects the locking lever 30 with a driving source 48, that will be described below. The connecting disk 37 is connected to the driving source 48 to receive a driving force provided by the driving source 48.

Movement guide ribs 38 are formed on an outer surface of the lever body 31. The movement guide ribs 38 protrude from outer surfaces of the lever body 31, and extend in a lengthwise direction of the lever body 31. The movement guide ribs 38 are formed on corresponding outer surfaces of the lever body 31. In the embodiment of the present invention, the movement guide ribs 38 are formed on an upper surface and a lower surface of the lever body 31 in the drawing. However, the locations of the movement guide ribs 38 may be variously changed.

Meanwhile, a configuration corresponding to the movement guide ribs 38 should be formed in the inlet housing 11 or the adapter bracket 40, which will be described below. For example, channels (no reference numeral is given) are formed to correspond to the movement guide ribs 38.

The adapter bracket 40 is attached to the mounting plate 12 of the inlet housing 11 along a periphery of the front surface of the mounting plate 12 of the inlet housing 11. The adapter bracket 40 is manufactured to be suitable for various types of panels of various vehicles so as to mount the inlet connector 10 to a panel. This is because various different adapter brackets 40 can be used in the same inlet connector 10 in various types of vehicles.

The bracket body 41 forms a frame of the adapter housing 40. The bracket body 41 is formed along a periphery of the mounting plate 12 of the inlet housing 11 to have a predetermined height. A penetration part 42 is formed to pass through a center of the bracket body 41. The plug coupling part 14 is located in the penetration part 42 to be exposed.

A plurality of coupling holes 43 for coupling to the mounting plate 12 of the inlet housing 11 are formed in the bracket body 41. A mounting piece 45 is formed at one side of the bracket body 41. The mounting piece 45 is adapted to mount the adapter bracket 40 to a panel of the vehicle.

A resilient member guide 46 is formed in the bracket body 41 at a location facing the insertion hole 17 formed in the plug insertion part 14 of the inlet housing 11. The resilient member guide 46 serves to support and guide one end of the resilient member 20′. The resilient member guide 46 may be formed in the mounting plate 12 of the inlet housing 11.

A driving source housing 47 is formed at one side of the bracket body 41. The driving source 48 is positioned within the driving source housing 47, and a driving source cover 47′ is provided to shield the driving source housing 47 from the outside. A communication hole (not illustrated) is formed such that an interior of the driving source housing 47 in which the driving source 48 is positioned and the penetration part 42 are communicated with each other. A connecting disk 37 of the locking lever 30 is located in the communication hole.

For reference, the driving source 48 may not be installed in the bracket body 41. The driving source 48 may be mounted to the mounting plate 12 of the inlet housing 11. Thereto, the mounting plate 12 should be larger than that illustrated in the embodiment. In this case, the driving source 48 is situated at a location corresponding to the penetration part 42 of the bracket body 41.

Meanwhile, in the present invention, the driving source 48 not only provides power but also includes a configuration for converting the power into a linear reciprocal movement of the locking lever 30. For example, it is defined in the specification that the driving source 48 includes a configuration for converting rotating power of the motor into a linear movement by using a pinion and a rack.

In the present invention, the driving source 48 is operated for a predetermined time period such that the locking lever 30 is moved to a location where the coupling latch 20 is locked, after the inlet connector 10 and the plug connector 50 are completely coupled to each other, and is operated for a predetermined time period such that the locking lever 30 is moved to a location where the coupling latch 20 can be released, after the charging is completed.

Next, a main part of the plug connector coupled to the inlet connector 10 will be described. The plug connector 50 is provided in the charging station, and a plug housing 52 forms an external appearance of the plug connector 50 as illustrated in FIG. 2. FIG. 2 is a sectional view illustrating a part of the plug housing 52. A tip end inclined surface 56 is formed on a tip end surface of the plug housing 52, and the tip end inclined surface 56 is formed such that it becomes downwardly inclined as it goes toward a tip end of the plug housing 52. The tip end inclined surface 56 guides the first inclined surface 22 of the coupling latch 20.

A coupling hole 54 is formed at one side of a tip end of the plug housing 52. The coupling hole 54 may not pass through the plug housing 52 and may be recessed. An inner inclined surface 58 is formed on an inner surface of the coupling hole 54 corresponding to a tip end of the plug housing 52. The inner inclined surface 58 guides the second inclined surface 23 of the coupling latch 20.

Hereinafter, an operation of the charging connector locking apparatus according to the embodiment of the present invention will be described.

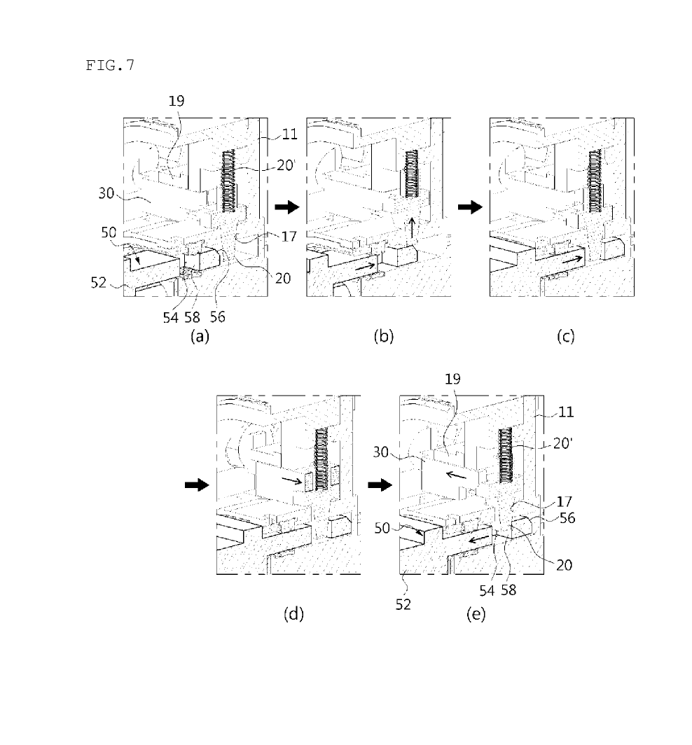

FIG. 7A illustrates a state in which the plug connector 50 has just entered the plug coupling part 14 of the inlet connector 10. Then, the coupling latch 20 is pushed by the resilient member 20′ to pass through the insertion hole 17 such that a tip end thereof is adjacent to an outer surface of the terminal installation part 15. The locking lever 30 is relatively retreated by the driving source 48. Here, the retreated state refers to a state in which the locking lever 30 is spaced apart from the locking arm 25 of the coupling latch 20 by a predetermined distance.

If the plug connector 50 continues to be inserted into the plug coupling part 14 such that the tip end inclined surface 56 at a tip end of the plug housing 52 starts to interlock with the first inclined surface 22 of the coupling latch 20, the coupling latch 20 starts to move upwards in the drawing while overcoming a resilient force of the resilient member 20′. That is, the coupling latch 20 starts to move far away from the terminal installation part 15. This state is illustrated in FIG. 7B.

If the latch 20 is moved in a direction away from the terminal installation part 15 and the plug connector 50 is completely inserted, the coupling hole 54 of the plug connector 50 is situated at a location corresponding to the insertion hole 17. Thus, the coupling latch 20 is pushed by the resilient member 20′ to enter the coupling hole 54. This state is illustrated in FIG. 7C. In this state, the terminal 16′ of the inlet connector 10 and a terminal of the plug connector 50 are coupled and electrically connected to each other. If the electrical connection is completed, the information is transferred to the driving source 48 and the driving source 48 is operated.

If the driving source 48 is operated, the locking lever 30 is linearly moved toward the coupling latch 20 as illustrated in FIG. 7D. In this process, the interlocking fingers 32 of the locking lever 30 are moved along opposite sides of the interlocking arm 25 of the coupling latch 20 and are located at an upper end of the latch body 21. That is, the interlocking fingers 32 are located at opposite ends of the connecting part 24.

Of course, a tip end of the interlocking arm 25 of the coupling latch 20 is located in the avoidance space 36 between the interlocking fingers 32 of the locking lever 30. In this process, the interlocking inclined surface 26 of the interlocking arm 25 mutually guides the arm interlocking inclined surface 35 of the locking lever 30, and the end interlocking inclined surface 27 of the interlocking fingers 32 mutually guides the end interlocking inclined surface 27 of the coupling latch 20 and guides interlocking of the locking lever 30 and the coupling latch 20. In the state of FIG. 7D, the locking lever 30 pushes the coupling latch 20 such that the coupling latch 20 cannot be moved.

Meanwhile, when the charging is completed, a charging completion signal is provided. The driving source 48 is operated in response to the signal. The locking lever 30 becomes spaced apart from the coupling latch 20 by the operation of the driving source 48. If the locking lever 30 is spaced apart from the coupling latch 20, the coupling latch 20 is in a movable state.

If an operator moves the plug connector 50 in a direction in which the plug connector 50 is separated from the inlet connector 10, the coupling latch 20 resiliently deforms the resilient member 20′ upwards while the inner inclined surface 58 of the coupling hole 54 and the second inclined surface 23 of the coupling latch 20 guide each other. If the coupling latch 20 is raised by a separation operation of the plug connector 50, it is withdrawn from the coupling hole 54 to be released from the plug connector 50. This process is illustrated in FIG. 7E.

For reference, the embodiment of the present invention may be modified as follows. For example, a movement guide channel may be recessed on an outer surface of the lever body 31 instead of or together with the movement guide rib 38. The movement guide channel extends in a lengthwise direction of the lever body 31 in the same manner as the movement guide rib 38. For example, movement guide channels may be formed on opposite surfaces of the lever body 31. The locations of the movement guide channels may be variously modified.

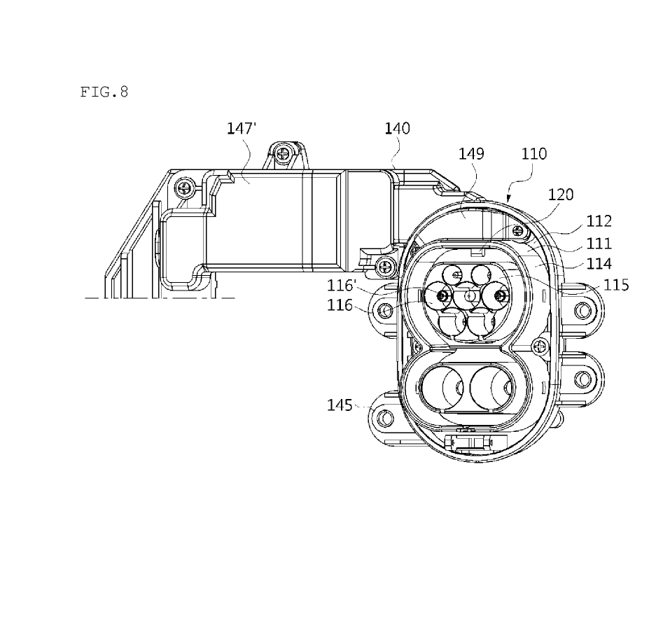

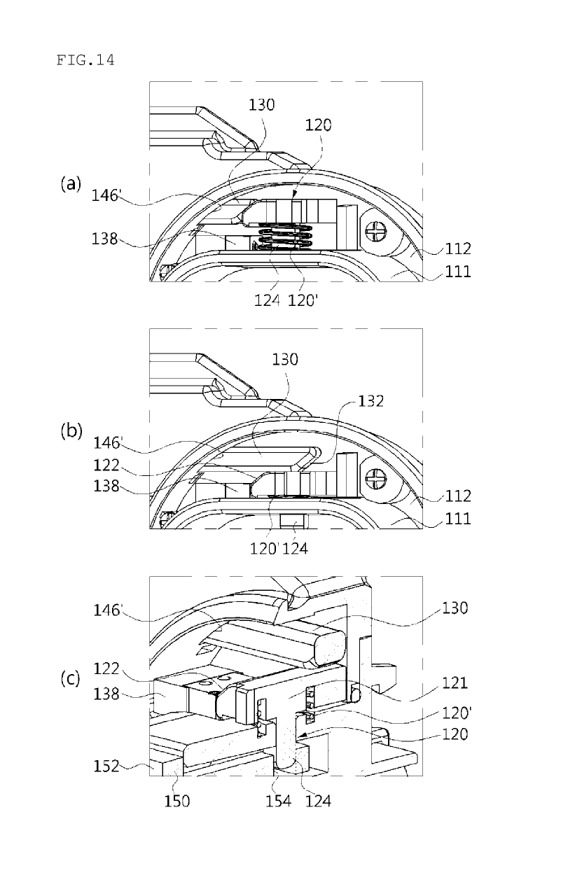

Next, a charging connector locking apparatus according to another embodiment of the present invention will be described with reference to FIGS. 8 to 14.

As illustrated in the drawings, an inlet connector 110 is adapted to charge a vehicle, and is a part mounted to one side of a vehicle such that a plug connector 150 of a charging station is coupled thereto. An inlet housing 111 forms an external appearance and a frame of the inlet connector 110. The inlet housing 111 is formed of a synthetic resin. A mounting plate 112 formed of an insulating synthetic resin is provided at a rear end of the inlet housing 111. A plug coupling part 114 that is substantially cylindrical protrudes from the mounting plate 112. A terminal installation part 115 that is cylindrical is formed in an interior of the plug coupling part 114. A terminal positioning space 116 passes through the terminal installation part 115 forward and rearward. A terminal 116′ formed of a conductive metal is located within the terminal positioning space 116.

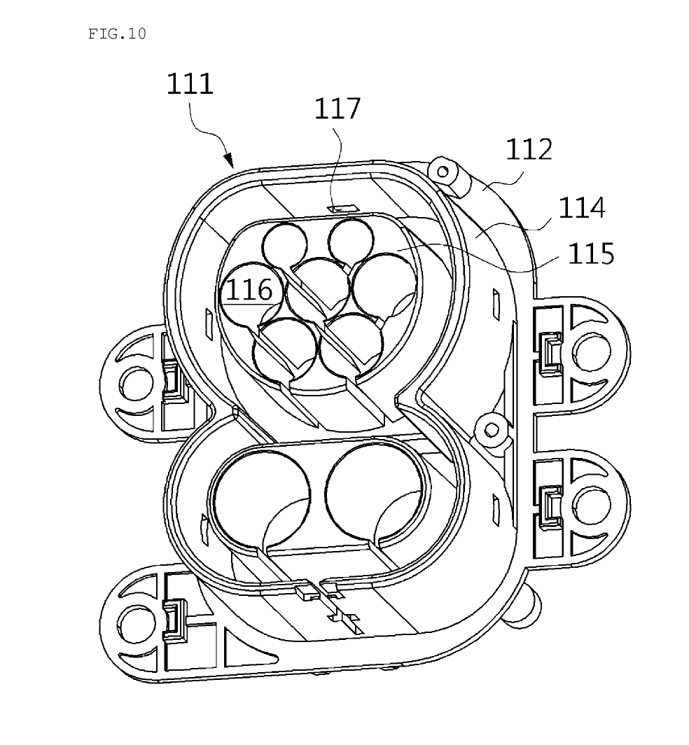

As illustrated in FIG. 10, an insertion hole 117 passes through the plug coupling part 114. The insertion hole 117 is a part through which a coupling latch 120, which will be described below, passes. The insertion hole 117 is a part that corresponds to a coupling hole 154 provided in a plug connector of a charging station when the plug connector 150 of the charging station is coupled to the inlet connector 110. For reference, a description of parts of the inlet connector 110 that do not correspond to the essence of the present invention will be omitted.

The coupling latch 120 is installed in the mounting plate 112 of the inlet housing 111 to pass the insertion hole 117 of the plug insertion part 114. The coupling latch 120 is supported by a resilient member 120′ to receive a force in a direction in which the coupling latch 120 is inserted into the insertion hole 117. In the embodiment of the present invention, a cylindrical coil spring is used as the resilient member 120′. The coupling latch 120 is located in the insertion hole 117 and the coupling hole 154 of the plug connector 150 at the same time to lock the inlet connector 110 and the plug connector 150 coupled to each other.

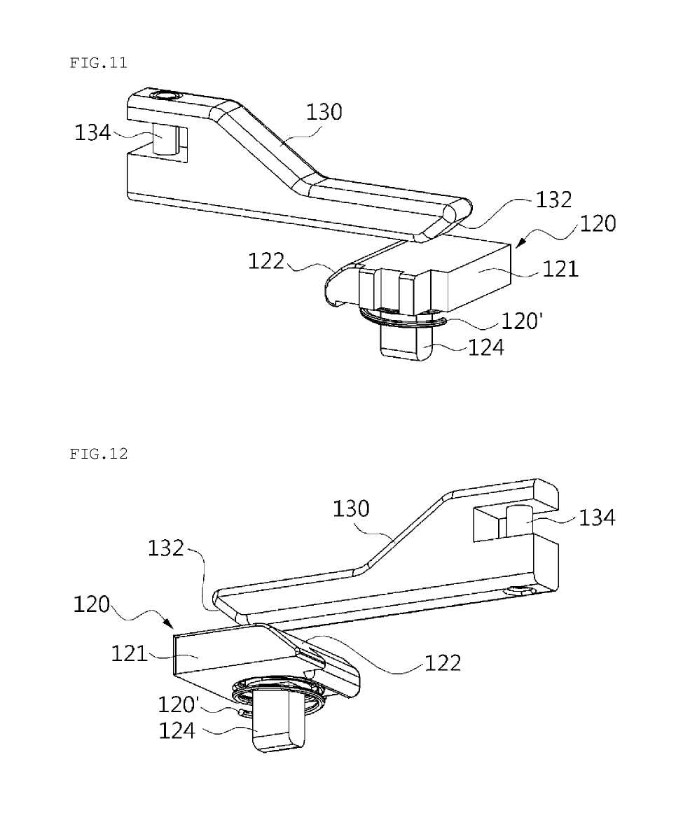

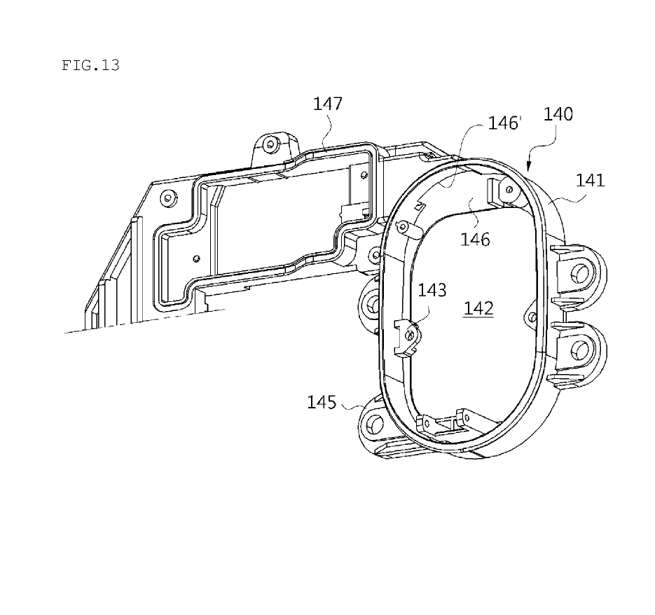

A shape of the coupling latch 120 is illustrated in FIGS. 11 and 12. The latch body 121 forms a frame of the coupling latch 120. The latch body 121 has a substantially hexahedral shape. Of course, the shape of the latch body 121 is not limited thereto. An interlocking inclined surface 122 is formed at one end of the latch body 121. The interlocking inclined surface 122 is downwardly inclined toward the locking lever 130, which will be described below.

A locking bar 124 that passes through the insertion hole 117 to be caught by the coupling hole 154 of the plug connector 150 is provided in the coupling latch 120. The locking bar 124 protrudes from a center of an outer surface of the latch body 121. A tip end, in particular, a periphery of a tip end of the locking bar 124 may be curved. This is because the locking bar 124 can be inserted into the coupling hole 154 more smoothly.

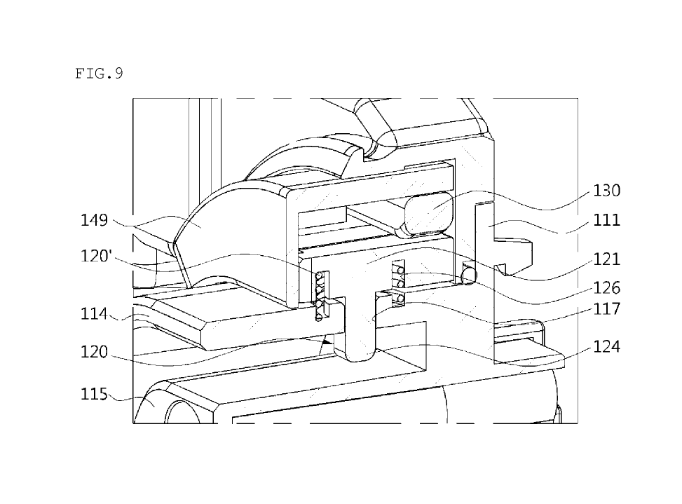

A positioning recess 126 (see FIG. 9) is formed on an outer surface of the latch body 121 where the locking bar 124 is formed around the locking bar 124. One end of the resilient member 120′ is positioned in the positioning recess 126. An opposite end of the resilient member 120′ is positioned in the positioning recess 114′ formed in the plug coupling part 114.

The locking lever 130 is provided to interlock with the coupling latch 120. The locking lever 130 is provided in the mounting plate 112 of the inlet housing 111 or a positioning plate 146 of an adapter bracket 140, which will be described below, and serves to drive the coupling latch 120. As illustrated in FIG. 9, the locking lever 130 receives a force applied by the coupling latch 120 while being supported by the mounting plate 112 or the positioning plate 146. In the illustrated embodiment, the locking lever 130 is supported by a cover 149, which will be described below, and the cover 149 is also substantially supported by the mounting plate 112 or the positioning plate 146. Thus, since both the mounting plate 112 and the positioning plate 146 are responsible for a force transferred to the locking lever 130 by the coupling latch 120, a size or strength of the locking lever 130 may be relatively weak.

The locking lever 130 has a long bar shape, and a driving inclined surface 132 interlocking with the interlocking inclined surface 122 of the coupling latch 120 is formed at a tip end of the locking lever 130. The driving inclined surface 132 operates the coupling latch 120 while being guided along the interlocking inclined surface 122. The locking lever 130 is driven by a driving source 148, which will be described below. Thereto, a connecting part 134 for coupling with the driving source 148 is located at a rear end of the locking lever 130.

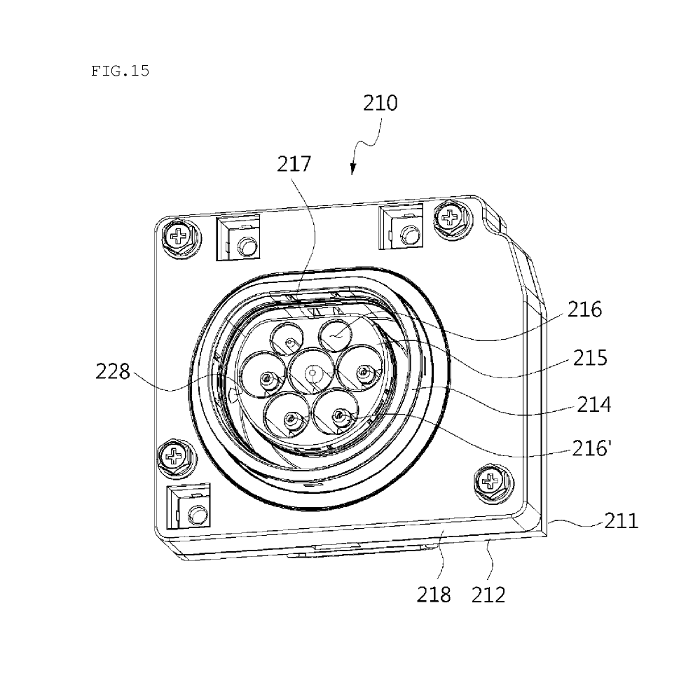

Meanwhile, a switch 138 (see FIG. 14) is provided adjacent to the coupling latch 120. The switch 138 is pushed by a tip end of the interlocking inclined surface 122 of the coupling latch 120. The switch 138 is adapted to detect a location of the coupling latch 120, and detects a state in which the coupling latch 120 locks the inlet connector 110 and the plug connector 150.

An adapter bracket 140 is attached along a periphery of a front surface of the mounting plate 112 of the inlet housing 111. The adapter bracket 140 is configured to mount the inlet connector 110 to various types of panels of a vehicle. That is, the adapter bracket 140 is used to mount the same inlet connector 110 to various types of panels. This is because various different adapter brackets 40 can be used in the same inlet connector 110 in various types of vehicles.

The bracket body 141 forms a frame of the adapter bracket 140. The bracket body 141 is formed along a periphery of the mounting plate 112 of the inlet housing 111 to have a predetermined height. A penetration part 142 is formed to pass through a center of the bracket body 141. The plug coupling part 114 is located in the penetration part 42 to be exposed.

A plurality of coupling holes 143 for coupling to the mounting plate 112 of the inlet housing 111 are formed in the bracket body 141. A mounting piece 145 is formed at one side of the bracket body 141. The mounting piece 145 is adapted to mount the adapter bracket 140 to a panel of the vehicle.

A positioning plate 146 is located at a penetration part 142 of the bracket body 141. The positioning plate 146 is a plate having a predetermined area, and is situated at a location corresponding to the coupling latch 120 and the locking lever 130. A communication hole 146′ is formed at a location where the positioning plate 146 is formed to be communicated with an interior of the driving source housing 147, which will be described below. The locking lever 130 passes through the communication hole 146′.

The driving source housing 147 is formed at one side of the bracket body 141. A driving source 148 is positioned within the driving source housing 147, and a driving source cover 147′ is provided to shield the driving source housing 147 from the outside.

For reference, the driving source 148 may not be installed in the bracket body 141. The driving source 148 may be mounted to the mounting plate 112 of the inlet housing 111. Thereto, the mounting plate 112 should be larger than that illustrated in the embodiment. In this case, the driving source 148 is situated at a location corresponding to the penetration part 142 of the bracket body 141.

Meanwhile, in the present invention, the driving source 148 not only provides power but also includes a configuration for converting the power into a linear reciprocal movement of the locking lever 130. For example, it is defined in the specification that the driving source 148 includes a configuration for converting rotating power of the motor into a linear movement by using a pinion and a rack. Of course, for example, when a solenoid is employed instead of a motor, a separate configuration for changing a movement direction is not necessary. In this case, the solenoid itself is a driving source 148.

In the present invention, the driving source 148 is operated such that the locking lever 130 can lock the coupling latch 120 after the coupling of the inlet connector 110 and the plug connector 150 is completed and such that the locking lever 130 can release the coupling latch 120 after the charging is completed. Reference numeral 149 denotes a latch cover, which shields tip ends of the coupling latch 120 and the locking lever 130, and the switch 138.

Next, only a main part of the plug connector 150 coupled to the inlet connector 110 will be described. The plug connector 150 is provided in a charging station, and the plug housing 152 forms an external appearance of the plug connector 150 as illustrated in FIG. 14. FIG. 14 is a sectional view illustrating a part of the plug housing 152.

A coupling hole 154 is formed at one side of a tip end of the plug housing 152. The coupling hole 154 may not pass through the plug housing 152, and may be recessed.

Hereinafter, an operation of the charging connector locking apparatus according to the embodiment of the present invention will be described.

FIG. 14A illustrates the coupling latch 120 and the locking lever 130 of the inlet connector 110 in a state in which the plug connector 150 is not coupled to the inlet connector 110. The coupling latch 120 is moved upwards in the drawing by the resilient member 120′. Thus, a tip end of the locking bar 124 of the coupling latch 120 is located in the insertion hole 117 of the plug coupling part 114. That is, the coupling latch 120 is situated at a location deviating from a movement passage into which the plug connector 150 is inserted.

If the plug connector 150 enters the plug insertion part 114 in this state, the terminal 116′ of the inlet connector 110 and a terminal of the plug connector 150 are coupled and electrically connected to each other. However, currents still cannot flow through the terminal.

One of the terminals 116′ is relatively long so that it is coupled first to provide a coupling signal. If the coupling signal is provided, the driving source 148 is operated. That is, the inlet connector 110 and the plug connector 150 are coupled to each other such that the coupling hole 154 of the plug connector 150 is situated at a location corresponding to the insertion hole 117 of the plug coupling part 114. If the driving source 148 is operated, the locking lever 130 is moved forward.

If the locking lever 130 is moved forward, the driving inclined surface 132 of the locking lever 130 pushes the coupling latch 120 while being moved along the interlocking inclined surface 122 of the coupling latch 120. That is, the coupling latch 120 enters the coupling hole 154 of the plug connector 150 while overcoming a resilient force of the resilient member 120′.

The locking bar 124 of the coupling latch 120 enters the coupling hole 154 such that the locking lever 130 is raised up to an upper side of the coupling latch 120 as illustrated in FIG. 14B.

In this state, a tip end of the interlocking inclined surface 122 of the coupling latch 120 pushes the switch 138. If the switch 138 is pushed, it can be seen that the coupling latch 120 is situated at a location for locking the plug connector 150. Currents flow through the terminals 116′ to perform charging.

FIG. 14C illustrates a state in which the plug connector 150 and the inlet connector 110 are coupled to each other and the coupling latch 120 is pushed by the locking lever 130 so as not to be operable. In this state, even if the plug connector 150 receives a force in a direction in which the plug connector 150 is separated from the inlet connector 110, it is not separated due to the coupling latch 120.

Meanwhile, if the charging is completed, a charging completion signal is provided. Of course, if the charging completion signal is provided, currents flowing between the terminal 116′ of the inlet connector 110 and a terminal of the plug connector 150 are stopped.

If the locking lever 130 is moved away from the coupling latch 120 such that the locking lever 130 is withdrawn from the coupling latch 120 by an operation of the driving source 148, the coupling latch 120 is moved by the resilient member 120′. That is, the locking bar 124 is withdrawn from the coupling hole 154 of the plug connector 150. If the locking bar 124 of the coupling latch 120 is withdrawn from the coupling hole 154, the plug connector 150 becomes separable from the inlet connector 110, and if the operator applies a force to the plug connector 150, the plug connector 150 is separated from the inlet connector 110.

The embodiment of the present invention may be modified as follows. For example, although the switch 138 is used in the embodiment of the present invention, the switch 138 is adapted to detect whether the coupling latch 120 is situated at a location for locking and is not necessarily used. Of course, since an operator error due to damage of the coupling latch 120 may be detected by using the switch 138, reliability of the apparatus can be further improved by using the switch 138.

In the embodiment of the present invention, the locking lever 130 is manipulated by using the driving source 148, but the operator may directly manipulate the locking lever 130. In this case, a portion of the locking lever 130 connected to the driving source 148 is exposed to the outside such that the operator can directly manipulate the locking lever 130.

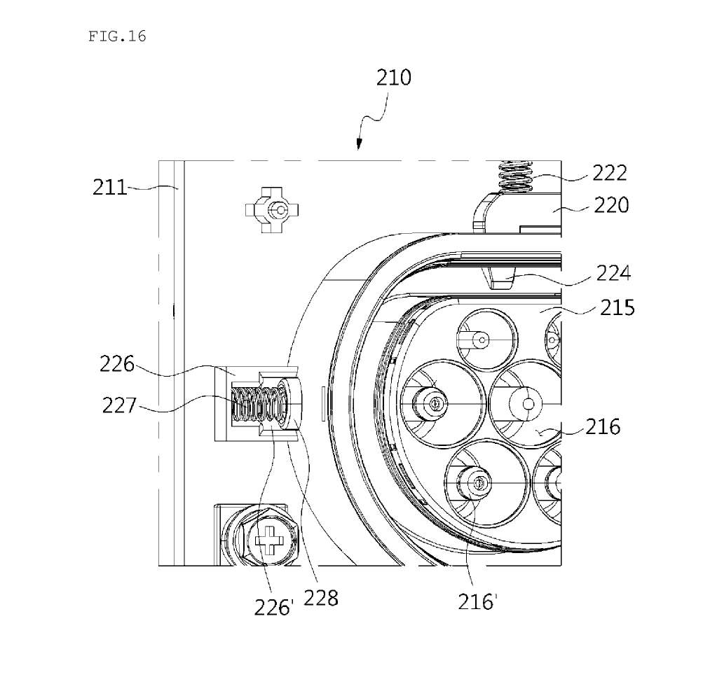

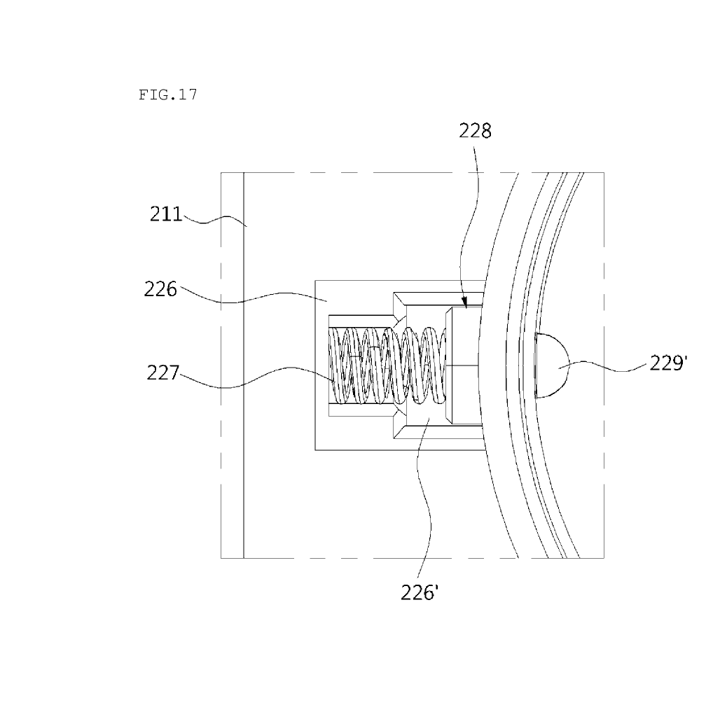

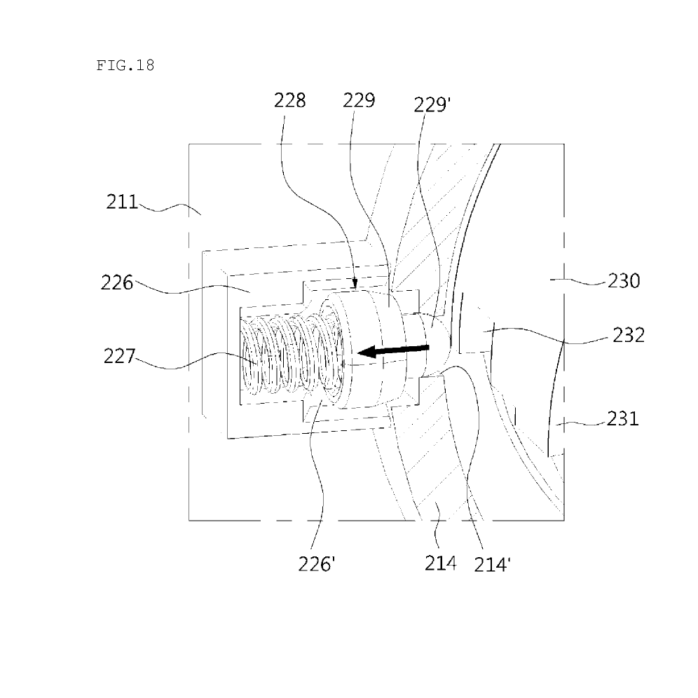

Another embodiment of the present invention will be described with reference to FIGS. 15 to 19.

As illustrated in the drawings, an inlet connector 210 is adapted to charge a vehicle, and is a part mounted to one side of a vehicle such that a plug connector 250 of a charging station is coupled thereto. An inlet housing 211 forms an external appearance and a frame of the inlet connector 210. The inlet housing 211 is formed of a synthetic resin. A mounting plate 212 formed of an insulating synthetic resin is provided at a rear end of the inlet housing 211. A plug coupling part 214 that is substantially cylindrical protrudes from the mounting plate 212. A terminal installation part 215 that is cylindrical is formed in an interior of the plug coupling part 214. A terminal positioning space 216 passes through the terminal installation part 215 forward and rearward. A terminal 216′ formed of a conductive metal is located within the terminal positioning space 216.

An insertion hole 217 is formed in the plug coupling part 214. The insertion hole 217 is a part through which a coupling latch 224 of a coupling lever 220, which will be described below, passes. The insertion hole 217 is a part that corresponds to a coupling hole (not illustrated) provided in a plug connector of a charging station when the plug connector 230 of the charging station is coupled to the inlet connector 210.

A tip end cover 218 is mounted to a front surface of the mounting plate 212. The tip end cover 218 serves to shield a front part of the housing 211 other than the plug insertion part 214. Various configurations, which will be described below, are installed between the tip end cover 218 and the mounting plate 212.

First, the locking lever 220 is installed in a space between the mounting plate 212 and the tip end cover 218. The locking lever 220 is driven by a separate driving source (not illustrated), and a tip end of the locking lever 220 is supported by a locking resilient member 222. A locking latch 224 passing through the insertion hole 217 is integrally formed with a tip end of the locking lever 220. An intermediate portion of the locking lever 220 is seesawed about a rotary shaft (not illustrated), and an opposite end of the locking lever 220 is connected to the driving source. The locking lever 220 serves to couple the inlet connector 210 and the plug connector 230 with the help of the driving of the driving source when the inlet connector 210 and the plug connector 230 are connected to each other. That is, if the locking latch 224 of the locking lever 220 passes through the insertion hole 217 to be caught by the coupling hole of the plug connector 230, the inlet connector 210 and the plug connector 230 are locked with each other.

Meanwhile, a box 226 is formed on a front surface of the mounting plate 212 of the housing 211 at a location corresponding to an outer surface of the plug insertion part 214. The box 226 has a receiving space 226′ opened toward a front side of the housing 211 therein. The receiving space 226′ of the box 226 is communicated with an interior of the plug insertion part 214 through a ball through-hole 214′ passing through the plug insertion part 214. The part of the receiving space 226′ opened toward a front side of the housing 211 is shielded by the tip end cover 218.

A resilient member 227 and a plunger 228 are located within the receiving space 226′. One end of the resilient member 227 is supported by one side of an inner surface of the receiving space 226′, and an opposite end of the resilient member 227 is supported by the plunger 228. The resilient member 227 may be a cylindrical coil spring. The resilient member 227 supports the plunger 228 such that one side of the plunger 228 protrudes into the plug insertion part 214 through the ball through-hole 214′.

A body 229 forms a frame and an external appearance of a plunger 228. In the embodiment of the present invention, the body 229 has a cylindrical shape and an end of the resilient member 227 is inserted into one end of the body 229. However, the body 229 may not be cylindrical. The body 229 has a shape and a size such that it cannot pass through the ball through-hole 214′ of the plug insertion part 214.

A ball portion 229′ protrudes from a tip end of the body 229. A cross-section of the ball portion 229′ is larger than that of the body 229. At least a tip end of the ball portion 229′ has a hemispherical shape. In the embodiment of the present invention, a part of the ball portion 229′ connected to the body 229 has a cylindrical shape, and a tip end of the ball portion 229′ has a hemispherical shape. The cylindrical part of the ball portion 229′ is located in the ball through-hole 214′ of the plug insertion part 214. The tip end of the ball part 229′ should be curved at least in an entrance/exit direction of the plug connector 230, which will be described below. This is because a tip end of the ball portion 229′ can be smoothly moved along an outer surface of the plug connector 230 in the positioning part 232 of the plug connector 230, which will be described below.

A plurality of plungers 228 supported by the resilient member 227 may protrude toward an inner surface of the plug insertion part 214. The plungers 228 may protrude toward the inner surface of the plug insertion part 214 at a predetermined separation.

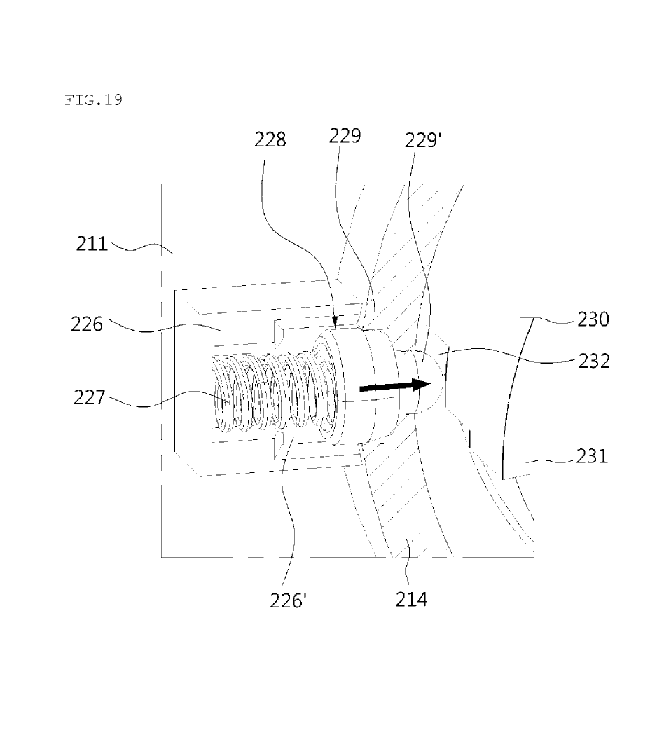

Only a part of the plug connector 230 coupled to the inlet connector 210 is illustrated in FIGS. 18 and 19 for convenience' sake. The plug connector 230 is located in the charging station, and is coupled to the inlet connector 210 to charge a battery of the vehicle. A positioning part 232 is provided on an outer surface of the plug housing 231 of the plug connector 230 at a location corresponding to the plunger 228. The positioning part 232 may be formed to be recessed on or pass through an outer surface of the plug housing 231 of the plug connector 230.

Hereinafter, use of the charging connector locking apparatus according to the embodiment of the present invention will be described in detail.

If a tip end of the plug connector 230 is inserted into the plug insertion part 214, the inlet connector 210 and the plug connector 230 are coupled to each other to perform a charging operation. Of course, the inlet connector 210 and the plug connector 230 are locked by the locking lever 220. In this state, the charging is completed.

In the process of inserting the plug connector 230 into the inlet connector 210, the ball portion 229′ of the plunger 228 is received in the ball through-hole 214′ by a tip end and an outer surface of the plug housing 231 of the plug connector 230. That is, the plunger 228 is moved into the receiving space 226′ while resiliently deforming the resilient member 227.

If the ball portion 229′ of the plunger 228 is pushed by the plug housing 231 from an interior of the plug insertion part 214 to an interior of the ball through-hole 214′ and the plug connector 230 is completely inserted into the inlet connector 210, the positioning part 232 of the plug housing 231 is located at a location corresponding to the ball portion 229′ and the ball portion 229′ enters the positioning part 232. This is because the resilient member 227 is restored to an original state.

If the resilient member 227 is restored to an original state and the ball portion 229′ enters the positioning part 232, the body 229 of the plunger 228 collides with a wall surface of the plug insertion part 214 in the receiving space 226′ and the operator can feel vibrations due to a sound or impact of the collision. Thus, the operator can confirm that the plug connector 230 is completely inserted into the inlet connector 210.

Meanwhile, since a tip end of the ball portion 229′ of the plunger 228 is curved and an intermediate part of the ball portion 229′ is located within the ball through-hole 214′ such that the plunger 228 is linearly moved, the ball portion 229′ can easily pass through a tip end of the plug housing 231 or a periphery of the positioning part 232 when the plug connector 230 is moved in a direction in which the plug connector 230 is coupled to or separated from the inlet connector 210. That is, the plunger 228 is linearly moved while guiding a tip end of the plug housing 231 or a periphery of the positioning part 232 to a curved surface of a tip end of the ball portion 229′.

Thus, it is the same when the plug connector 230 is separated from the inlet connector 210. If the locking lever 220 is operated by driving of the driving source as the charging is completed and the locking latch 224 is withdrawn from the coupling hole of the plug connector 230, the operator can separate the plug connector 230 from the inlet connector 210.

If the operator applies a force to the plug connector 230 in a direction in which the plug connector 230 is separated from the inlet connector 210, the curved surface of the ball portion 229′ is guided to a periphery of the positioning part 232 of the plug connector 230 such that the plunger 228 is moved, and the ball portion 229′ enters the ball through-hole 214′ of the plug insertion part 214. By doing so, the plug connector 230 can be separated from the inlet connector 210.

For reference, if the ball portion 229′ is inserted into the positioning part 232 of the plug connector 230, the plug connector 230 can be prevented from being withdrawn from the inlet connector 210. If a plurality of plungers 228 are provided at a predetermined angular separation, the plug connector 230 can be accurately coupled to the inlet connector 210 as a whole.

Although the box 226 is formed on a front surface of the mounting plate 212 of the housing 211 such that the resilient member 227 and the plunger 228 are installed in the embodiment of the present invention, the box 226, the resilient member 227, and the plunger 228 may be located on a rear surface of the mounting plate 212 of the housing 211. In this case, the locking lever 220 also may be located on a rear surface of the mounting plate 212. The box 226 may be situated at any location of the housing 211.

The scope of the present invention is not limited by the embodiments and is defined by the claims, and it is apparent that those skilled in the art to which the present invention pertains can variously modify and change the present invention without departing from the scope of the present invention.

The present invention relates to a charging connector locking apparatus including an inlet connector and a plug connector, and can prevent the inlet connector and the plug connector from being separated from each other while the inlet connector and the plug connector are coupled to each other such that a battery is charged. Thus, the present invention can be applied to a vehicle for driving a motor by using a battery.

1-12. (canceled)

13. A charging connector locking apparatus for locking a coupled state of an inlet connector and a plug connector of a charging station when the inlet connector is coupled to the plug connector for charging, the apparatus comprising:
a coupling latch installed at one side of an inlet housing of the inlet connector and supported by a resilient member at a location deviating from a movement passage through which the plug connector moves; and
a locking lever configured to control movement of the coupling latch, for fixing the coupling latch in a state the coupling latch is positioned in a coupling hole of the plug connector while the plug connector is coupled to the inlet connector.

14. The apparatus of claim 13, further comprising a driving source for driving the locking lever, wherein the driving source is operated in a state in which terminals of the plug connector and the inlet connector are coupled to each other to drive the locking lever.

15. The apparatus of claim 13, further comprising a switch provided at a location adjacent to the coupling latch, for detecting a state in which the coupling latch is moved and fixed by the locking lever.

16. The apparatus of claim 13, wherein a mounting plate is formed at a rear end of the inlet housing, an adapter bracket is provided along a periphery of the mounting plate, a bracket body is formed in the adapter bracket along a periphery of the mounting plate to have a predetermined height, a penetration part through which a plug insertion part of the inlet housing is exposed is formed to pass through a center of the bracket body, and a mounting piece for mounting an adapter bracket to a panel of a vehicle is formed at one side of the bracket body.

17. (canceled)

18. The apparatus of claim 13, wherein the coupling latch and the locking lever are installed in a mounting plate formed in an inlet housing of the inlet connector and a positioning plate formed in a penetration part of the adapter bracket.

19. The apparatus of claim 13, wherein an interlocking inclined surface guiding a driving inclined surface at a tip end of the locking lever is formed at one end of a latch body forming a frame of the coupling latch, and a locking bar protrudes from one surface of the latch body to be located in an insertion hole of the inlet connector and a coupling hole of the plug connector.

20. The apparatus of claim 19, wherein one end of a resilient member supporting the coupling latch is positioned in a positioning recess formed around a locking bar of the latch body, and an opposite end of the resilient member is positioned in a positioning recess formed around an insertion hole passing through the plug coupling part provided in the inlet connector.

21. The apparatus of claim 20, wherein a tip end of the locking bar of the coupling latch is curved, and is located in the insertion hole by the resilient member and is inserted into a coupling hole of the plug connector by the locking member.

22. A charging connector locking apparatus for locking a coupled state of an inlet connector and a plug connector of a charging station when the inlet connector is coupled to the plug connector for charging, the apparatus comprising:
a coupling latch supported by a resilient member of the plug connector in a direction away from a coupling hole formed in the plug connector such that a tip end of the coupling latch is located in an insertion hole formed at one side of an inlet housing of the inlet connector;
a driving source for providing driving power for insertion of the coupling latch into the coupling hole of the plug connector; and
a locking lever operated by the driving source to control movement of the coupling latch, for moving and fixing the coupling latch such that the coupling latch is positioned in a coupling hole of the plug connector while the plug connector is coupled to the inlet connector.

23. The apparatus of claim 22, wherein an interlocking inclined surface guiding a driving inclined surface at a tip end of the locking lever is formed at one end of the latch body forming a frame of the coupling latch, and a locking bar protrudes from one surface of the latch body to be pushed by the locking lever so as to be located in an insertion hole of the inlet connector and a coupling hole of the plug connector.

24. The apparatus of claim 23, wherein one end of a resilient member supporting the coupling latch is positioned in a positioning recess formed around a locking bar of the latch body, and an opposite end of the resilient member is positioned in a positioning recess formed around an insertion hole passing through the plug coupling part provided in the inlet connector.

25. The apparatus of claim 24, wherein a tip end of the locking bar of the coupling latch is curved, and is located in the insertion hole by the resilient member and is inserted into a coupling hole of the plug connector by the locking member.

26. The apparatus of claim 22, further comprising a switch provided at a location adjacent to the coupling latch, for detecting a state in which the locking lever is moved and fixed by the locking lever.

27. The apparatus of claim 26, wherein a mounting plate is formed at a rear end of the inlet housing, an adapter bracket is provided along a periphery of the mounting plate, a bracket body is formed in the adapter bracket along a periphery of the mounting plate to have a predetermined height, a penetration part through which a plug insertion part of the inlet housing is exposed is formed to pass through a center of the bracket body, and a mounting piece for mounting an adapter bracket to a panel of a vehicle is formed at one side of the bracket body.

28. The apparatus of claim 27, wherein a driving source housing in which the driving source is positioned is integrally formed with one side of the adapter bracket and the locking lever passes through the bracket body such that an interior of the driving source housing is communicated with the penetration part.

29. A charging connector locking apparatus for fixing a state in which an inlet connector for charging is coupled to a plug connector of a charging station, the apparatus comprising:
a box formed at one side of a housing forming an external appearance of the inlet connector and having a receiving space therein; and
a plunger formed at one side of the housing, and having a ball portion passing through a plug insertion part into which a tip end of the plug connector is inserted to be supported by a resilient member in the receiving space of the box and protruding into a plug insertion part toward an outer surface of a plug housing of the plug connector,
wherein the ball portion protrudes into the plug insertion part to be positioned in a positioning part formed in the plug housing by a resilient force of the resilient member.

30. The apparatus of claim 29, wherein a ball through-hole passes through the plug insertion part to communicate the receiving space of the box with an interior of the plug insertion part.

31. The apparatus of claim 30, wherein the plunger comprises:
a body located within the receiving space and having a size larger than the ball through-hole; and
a ball portion protruding from a tip end of the body and located in the ball through-hole such that a tip end of the ball portion is curved to protrude into the plug insertion part so as to be guided along an outer surface of the plug housing of the plug connector.

32. The apparatus of claim 29, wherein a tip end of the ball portion is curved at least in a movement direction of the plug connector.

33-34. (canceled)
